(19) United States
(12) Patent Application Publication
(10) Pub. No.: US 2026/0075469 A1
(43) Pub. Date: Mar. 12, 2026

(54) RESOURCE BLOCK RESERVATION FOR CELL EDGE DEVICES IN WIRELESS COMMUNICATION NETWORKS

(71) Applicant: T-MOBILE INNOVATIONS LLC, Overland Park, KS (US)

(72) Inventor: Krunal Mansukhlal Modasiya, Aldie, VA (US)

(21) Appl. No.: 18/882,456

(22) Filed: Sep. 11, 2024

(51) Int. Cl. H04W 28/26; H04B 17/309; H04W 56/00; H04W 72/12

(52) U.S. Cl. CPC H04W 28/26; H04B 17/346; H04W 56/0045; H04W 72/12

(57) ABSTRACT

Various embodiments include a system that comprises processing circuitry and radio circuitry. The processing circuitry reserves a set of resource blocks for user devices located in a cell edge of a cell provide by an access node. The processing circuitry determines a user device is located in the cell edge. The processing circuitry schedules the user device in the set of resource blocks reserved for the user devices located in the cell edge. The radio circuitry wirelessly exchanges user data with the user device based on the schedule.

### TECHNICAL FIELD

Various embodiments of the present technology relate to wireless interference mitigation, and more specifically, to reserving resource blocks for user devices located in the cell edge to mitigate intercell interference.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

RANs provide service to user devices in geographic areas referred to as cells. Each cell utilizes one or more radio frequency bands to serve the user devices. The radio frequency bands that link the RANs and user devices are divided into sections of frequency referred to as resource blocks. The resource blocks are used to carry the data and signaling between the RAN and user devices within the cell. The cells of geographically proximate RANs overlap to ensure service continuity between the RANs. The overlapped region is referred to as the cell edge. In the overlapped region, both RANs utilize their resource blocks to broadcast wireless signals to their respective cell edge user devices. The time and frequency domains of the resource blocks used by both RANs may be similar. This increases the radio interference experienced by user devices at the cell edge thereby degrading the overall user experience. Unfortunately, some wireless communication networks may not always efficiently serve user devices at the cell edge. Moreover, some wireless communication networks may not always effectively mitigate intercell interference at the cell edge.

### Overview

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for wireless interference mitigation. Some embodiments comprise a method. The method comprises reserving a set of resource blocks for user devices located in a cell edge. The method further comprises determining a user device is located in the cell edge. The method further comprises scheduling the user device using the set of resource blocks reserved for the user devices located in the cell edge. The method further comprises wirelessly exchanging user data with the user device based on the scheduling.

Some embodiments comprise a system. The system comprises processing circuitry and radio circuitry. The processing circuitry reserves a set of resource blocks for user devices located in a cell edge. The processing circuitry determines a user device is located in the cell edge. The processing circuitry schedules the user device in the set of resource blocks reserved for the user devices located in the cell edge. The radio circuitry wirelessly exchanges user data with the user device based on the schedule.

Some embodiments comprise one or more non-transitory computer readable storage media having program instructions stored thereon. When executed by a computing system, the program instructions direct the computing system to perform operations. The operations comprise reserving a set of resource blocks for user devices located in a cell edge. The operations further comprise determining a user device is located in the cell edge. The operations further comprise scheduling the user device using the set of resource blocks reserved for the user devices located in the cell edge. The operations further comprise directing a radio to wirelessly exchange user data with the user device based on the scheduling.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example communication network that implements resource block reservation for cell edge devices.

FIG. 2 illustrates an exemplary operation of the communication network that implements resource block reservation for cell edge devices.

FIG. 3 illustrates another exemplary operation of the communication network that implements resource block reservation for cell edge devices.

FIG. 4 illustrates an exemplary access node in the communication network that implements resource block reservation for cell edge devices.

FIG. 5 illustrates an example Fifth Generation (5G) communication network that implements resource block reservation for cell edge devices.

FIG. 6 illustrates an example 5G User Equipment (UE) in the 5G communication network that implements resource block reservation for cell edge devices.

FIG. 7 illustrates an example 5G Radio Access Network (RAN) in the 5G communication network that implements resource block reservation for cell edge devices.

FIG. 8 illustrates an example Network Function Virtualization Infrastructure (NFVI) in the 5G communication network that implements resource block reservation for cell edge devices.

FIG. 9 further illustrates the NFVI in the 5G communication network that implements resource block reservation for cell edge devices.

FIG. 10 illustrates an exemplary operation of the 5G communication network that implements resource block reservation for cell edge devices.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

In conventional wireless communication networks, Radio Access Networks (RANs) schedule user devices to receive downlink data and signaling in resource blocks. The resource blocks comprise frequency domain resources the RANs use to encode the data/signaling and time domain resources to control transmission/reception time. The RANs transfer the downlink data to the user devices based on the resource block scheduling. The cells served by geographically proximate RANs, referred to as neighboring RANs, overlap to reduce gaps in wireless coverage. The RANs select the resource blocks at random. As such, a RAN may schedule a user device in the cell edge to receive data on the same resource block used by the neighboring RAN to communicate with another user device at the cell edge. For example, the resource blocks used by neighboring RANs to communicate with edge user devices may share time or frequency domain resources. The overlapped scheduling results into poor Signal-to-Interference-Plus-Noise Ratio (SINR) which degrades the user experience.

To overcome the above-described problems in conventional wireless communication networks, various embodiments of the present technology relate to resource block reservation for cell edge devices. In some examples, a RAN tracks the distance between the RAN and the user devices based on timing advance signals to determine which user devices are at the cell edge. The RAN interfaces with neighboring RANs to reserve resource blocks for cell edge user devices and avoid scheduling cell edge user devices on the same resource blocks. The RAN schedules edge user devices using the reserved resource blocks. The RAN wirelessly exchanges user data with the edge user devices based on the scheduling. Coordinating with neighboring RANs to reserve resource blocks for edge user devices to avoid scheduling edge user devices on the same resource blocks reduces edge interference thereby enhancing the overall user experience. Now referring to the Figures.

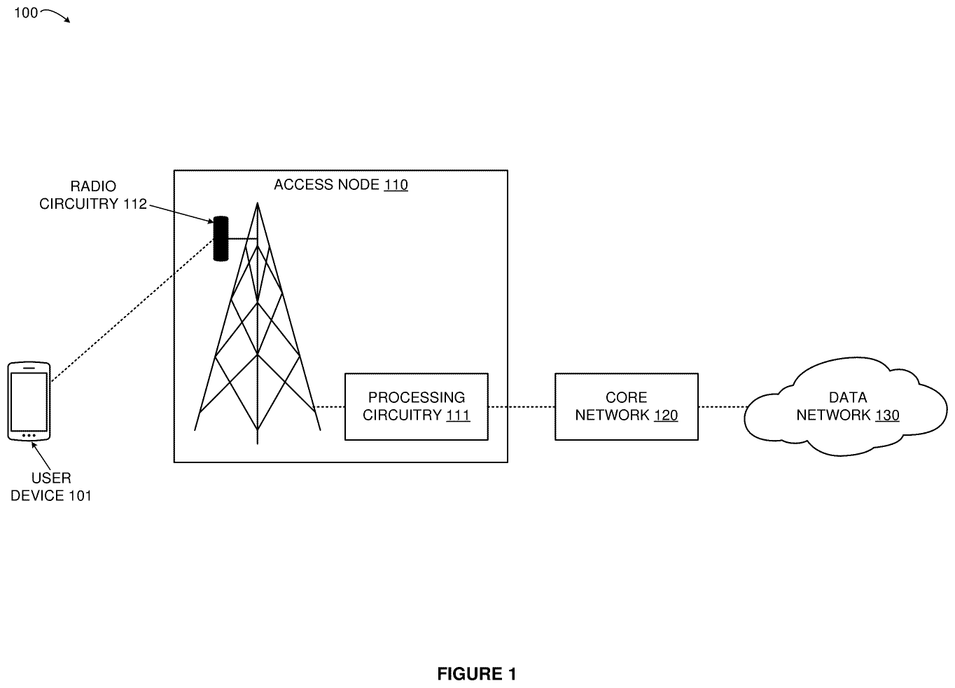

FIG. 1 illustrates communication network 100 to reserve resource blocks for cell edge devices. Communication network 100 provides services like media-streaming, internet-access, voice/video calling, text messaging, online gaming, social media, machine communications, or some other wireless communications product. Communication network 100 comprises user device 101, access node 110, core network 120, and data network 130. Access node 110 comprises processing circuitry 111 and radio circuitry 112. In other examples, communication network 100 may comprise additional or different elements than those illustrated in FIG. 1.

Various examples of network operation and configuration are described herein. In some examples, user device 101 attaches to access node 110 over radio circuitry 112. Processing circuitry 111 exchanges signaling with user device 101 to establish wireless data and signaling links. User device 101 communicates with core network 120 over access node 110 to request wireless data services over access node 110. Core network 120 approves the service request and directs access node 110 to service user device 101. User device 101 wirelessly exchanges user data processing circuitry 111 over radio circuitry 112. Processing circuitry 111 exchanges the user data with core network 120. Core network 120 exchanges the user data with data network 130. Access node 110 serves user devices in a geographic area referred to as a cell.

Access node 110 and user device 101 communicate over a radio frequency band. The radio frequency band comprises a range of radio spectrum with radio channels for wireless communication. For example, the N41 radio frequency band is a Fifth Generation New Radio (5GNR) frequency band that spans 2496-2690 MHz. The radio channels in the frequency band are divided into subcarriers which comprise chunks of bandwidth. Adjacent subcarriers are grouped to form resource blocks. Each resource block typically comprises 12 subcarriers. Processing circuitry 111 schedules user device 101 to send and receive wireless signals in the resource blocks and controls radio circuitry 112 to encode user device 101's signaling/data in the subcarriers of the scheduled resource blocks. Processing circuitry 111 reserves a set of resource blocks for user devices in the cell edge (e.g., the edge of the geographic area served by access node 110). Processing circuitry 111 determines when user device 101 is located in the cell edge. When user device 101 is located in the cell edge, processing circuitry 111 schedules user device 101 to receive (and/or transmit) data in the set of resource blocks reserved for cell edge devices. Processing circuitry 111 controls radio circuitry 112 to exchange data with the user device based on the scheduling.

Advantageously, communication network 100 efficiently serves user devices at the cell edge. Moreover, communication network 100 effectively mitigates intercell interference at the cell edge.

User device 101 may comprise a vehicle, drone, robot, computer, phone, sensor, or another type of data appliance with wireless and/or wireline communication circuitry. User device 101 and access node 110 may communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WiFi), IEEE 802.3 (Ethernet), Low-Power Wide Area Network (LP-WAN), Bluetooth, and/or some other type of wireless and/or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Although access node 110 is illustrated as comprising a tower, access node 110 may comprise another type of mounting structure (e.g., a building), or no mounting structure at all.

Access node 110 may comprise a Sixth Generation (6G) Radio Access Network (RAN) node, Fifth Generation (5G) RAN node, LTE RAN node, gNodeB, eNodeB, Narrow Band Internet-of-Things (NB-IoT) access node, trusted non-Third Generation Partnership Project (3GPP) access node, untrusted non-3GPP access node, Low Power-Wide Area Network (LP-WAN) base station, wireless relay, WiFi hotspot, Bluetooth access node, Ethernet access node, and/or another type of wireless or wireline network transceiver. Access node 110 exchanges network signaling and user data with network functions clustered together into core network 120. Access node 110 is connected to core network 120 over one or more backhaul data links. Access node 110 and core network 120 may communicate via edge networks like internet backbone providers, edge computing systems, or another type of edge system to provide the backhaul data and signaling links between access node 110 and core network 120.

Access node 110 may comprise Radio Units (RUs), Distributed Units (DUs) and Centralized Units (CUs). For example, processing circuitry 111 may be representative of a DU and a CU while radio circuitry 112 may be representative of an RU. The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUs handle higher wireless network layers like the Radio Resource Control (RRC), Service Data Adaption Protocol (SDAP), and Packet Data Convergence Protocol (PDCP). The CUs are coupled to network functions in core network 120.

Core network 120 is representative of computing systems that provide wireless data services to user device 101 over access node 110. Exemplary computing systems comprise Network Function Virtualization Infrastructure (NFVI) systems, data centers, server farms, cloud computing networks, hybrid cloud networks, and the like. Core network 120 may comprise a 3GPP core network architecture like Sixth Generation Core (6GC), Fifth Generation Core (5GC), Evolved Packet Core (EPC), and/or another type of 3GPP core network architecture. Access node 110, core network 120, and data network 130 communicate over various links that use metallic links, glass fibers, radio channels, or some other communication media. The links use 6GC, 5GC, EPC, Ethernet, Time Division Multiplex (TDM), Data Over Cable System Interface Specification (DOCSIS), Internet Protocol (IP), General Packet Radio Service Transfer Protocol (GTP), 6GR, 5GNR, LTE, WiFi, virtual switching, inter-processor communication, bus interfaces, and/or some other data communication protocols. The computing systems of core network 120 store and execute the network functions/entities to form a control plane and a user plane. Exemplary control plane network functions include Access and Mobility Management Function (AMF), Session Management Function (SMF), Unified Data Management (UDM), Policy Control Function (PCF), Mobility Management Entity (MME), Policy and Rules Charging Function (PCRF), Home Subscriber Server (HSS), and the like. Exemplary user plane network functions include User Plane Functions (UPF), Packet Gateway (P-GW), Serving Gateway (S-GW), and the like.

Data network 130 comprises an Application Server (AS) that hosts applications (e.g., media streaming applications, social media applications, IoT applications, online gaming applications, etc.) for user device 101. Data network 130 may be representative of a public data network (e.g., the Internet) or a private data network (e.g., an enterprise network). Core network 120 and data network 130 may communicate via links provided by internet backbone providers, edge computing services, and/or other communication services that provide the data links between core network 120 and data network 130.

User device 101 and access node 110 comprise antennas, amplifiers, filters, modulation, analog/digital interfaces, microprocessors, software, memories, transceivers, bus circuitry, and the like. User device 101, access node 110, core network 120, and data network 130 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), Analog Processing Units (APUs), and/or the like. The memories comprise Random Access Memory (RAM), Solid State Drives (SSDs), Hard Disk Drives (HDDs), Non-Volatile Memory Express (NVMe) SSDs, and/or the like. The memories store software like operating systems, user applications, radio applications, and network functions. The microprocessors retrieve the software from the memories and execute the software to drive the operation of communication network 100 as described herein.

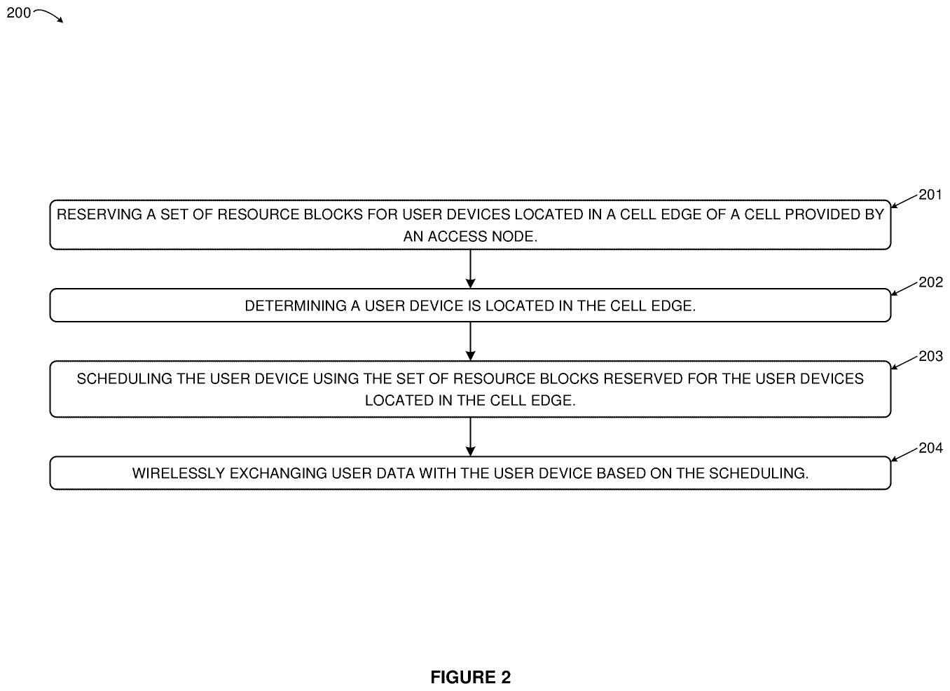

FIG. 2 illustrates process 200. Process 200 comprises an exemplary operation of communication network 100 to reserve resource blocks for cell edge devices. Process 200 may vary in other examples. The operations of process 200 comprise reserving a set of resource blocks for user devices located in a cell edge of a cell provided by an access node (step 201). The operations further comprise determining a user device is located in the cell edge (step 202). The operations further comprise scheduling the user device using the set of resource blocks reserved for the user devices located in the cell edge (step 203). The operations further comprise wirelessly exchanging user data with the user device based on the scheduling (step 204).

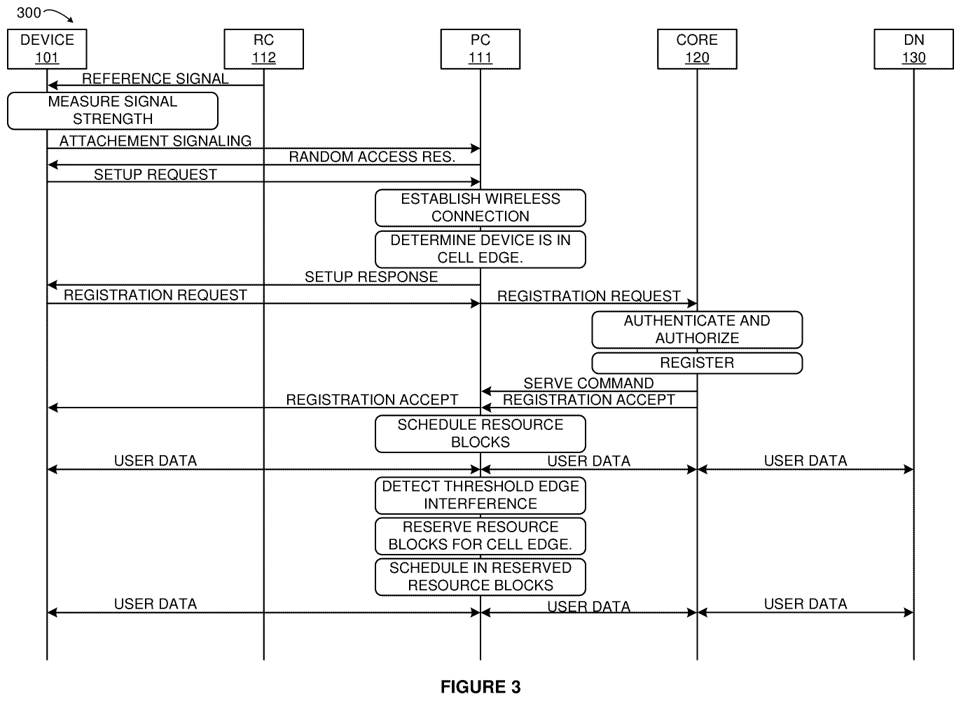

FIG. 3 illustrates process 300. Process 300 comprises an exemplary operation of communication network 100 to reserve resource blocks for cell edge devices. Process 300 comprises an example of process 200 illustrated in FIG. 2, however process 200 may differ. Process 300 may vary in other examples. In some examples, radio circuitry (RC) 112 broadcasts reference signals. The reference signals include information which is used by user devices to initiate communications with access node 110. User device 101 receives the reference signals and measures signal strength of the signals. When the signal strength of the reference signals exceeds quality and/or strength thresholds (e.g., Received Signal Received Power (RSRP) thresholds, Received Signal Received Quality (RSRQ) thresholds, etc.), user device 101 decides to attach to access node 110.

User device 101 transfers attachment signaling to processing circuitry (PC) 111 over radio circuitry 112 based on the reference signal. Processing circuitry 111 returns a random access response (RES.) to user device 101 over radio circuitry 112. The response comprises information like a timing advance command, uplink grant, and temporary identifier. User device 101 generates and transfers a connection setup request using the uplink grant as the time specified by the timing advance command to processing circuitry 111 over radio circuitry 112. For example, the connection setup request may comprise a Radio Resource Control (RRC) setup request. Processing circuitry 111 allocates radio resources to user device 101 to establish the wireless connection to user device 101. Processing circuitry 111 determines the distance between access node 110 and user device 101 based on the setup request. For example, processing circuitry 111 may determine the difference between the transmission time specified by the timing advance command and the reception time of the setup request and correlate this time to a distance. Alternatively, user device 101 may include location information (e.g., Global Positioning System (GPS) coordinates in the setup request and processing circuitry 111 may determine the distance of user device 101 based on the location information. Processing circuitry 111 determines user device 101 is located in the cell edge of access node 110 based on the distance. Processing circuitry 11 transfers a setup response to user device 101 over radio circuitry 112. The setup response includes signaling radio bearer configurations and cell identifiers (IDs) to facilitate communication between user device 101 and core network 120.

In response to connection setup, user device 101 transfers a registration request to core network 120. The registration request includes information like subscriber ID, device capabilities, Protocol Data Unit (PDU) session request requests, and the like. Core network 120 authenticates user device 101 and authorizes user device 101 for service on communication network 100. Responsive to authentication and authorization, core network 120 registers user device 101 for service on communication network 100. Core network 120 directs processing circuitry 111 to serve user device 101 and transfers a registration accept message for user device 101 to processing circuitry 111. The registration accept message includes information like device context, network addresses, and/or other information for user device 101 to begin its data session.

Processing circuitry 111 transfers the registration accept message to user device 101 over radio circuitry 112. Processing circuitry 111 schedules user device 101 in resource blocks for data reception/transmission. Processing circuitry 111 controls radio circuitry 112 to wirelessly exchange user data with user device 101 based on the scheduling. Processing circuitry 111 exchanges the user data with core network 120 which in turn exchanges the user data with data network 130.

Processing circuitry 111 monitors the interference level in the cell edge of access node 110. It should be appreciated that the geographic areas served by access nodes often overlap. Moreover, user devices located in the cell edge often require high transmission power to communicate with their access nodes. As such, cell edge interference can become excessive. Exemplary cell edge interference sources include neighbor cell and serving cell downlink/uplink wireless transmissions, particularly during heavy cell edge loading. For example, processing circuitry 111 may measure SINR for downlink transmission at the location of radio circuitry 112 and/or may receive SINR measurements from cell edge user devices (including user device 101) to monitor SINR at the locations of the cell edge user devices. Processing circuitry 111 compares the cell edge interference to an interference threshold (e.g., an operator configured or machine learning selected SINR threshold) to determine when cell edge interference is excessive.

When the average cell edge interference exceeds the threshold, processing circuitry 111 reserves a set of resource blocks in its served frequency band for user devices located in the cell edge. For example, access node 110 may serve a frequency band divided into 100 resource blocks and processing circuitry 111 may reserve resource blocks 80-100 for user devices located in the cell edge of access node 110. User devices that are not located in the cell edge may still receive any available resource block, include blocks 80-100 reserved for cell edge devices.

Processing circuitry 111 may interface with neighboring access nodes, also known as neighbor cells, (e.g., over X2 links) so that the reserved cell edge resource blocks of access node 110 differ from the cell edge resource blocks reserved by the neighbor cell. Since processing circuitry 111 determined user device is located in the cell edge, processing circuitry 111 schedules user device 101 in the reserved resource blocks in response to the direction from core network 120. Processing circuitry 111 controls radio circuitry 112 to wirelessly exchange user data with user device 101 based on the scheduling. Processing circuitry 111 exchanges the user data with core network 120 which in turn exchanges the user data with data network 130.

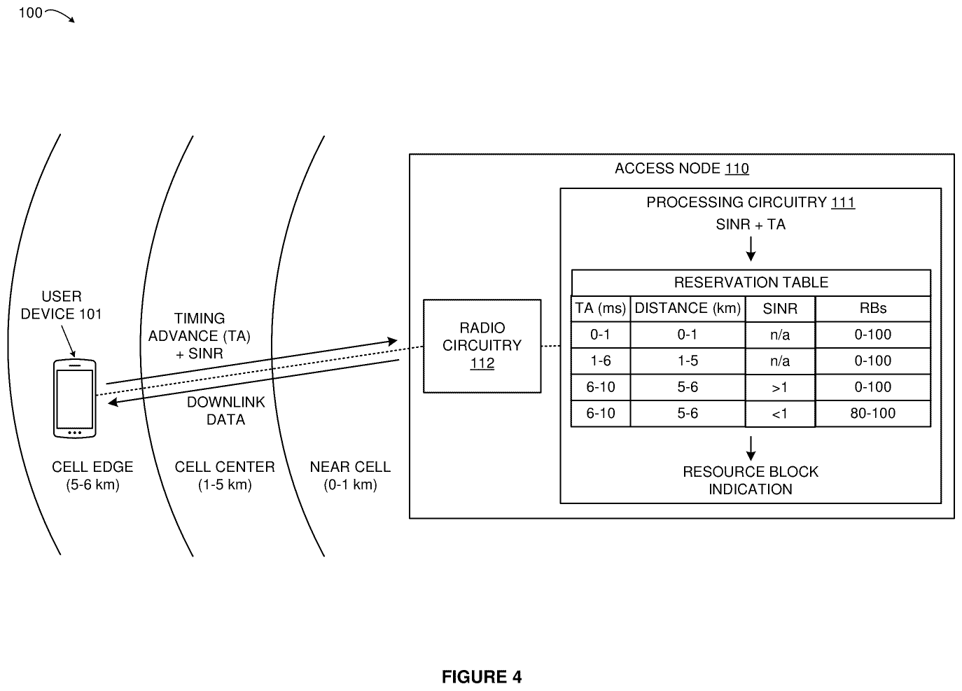

FIG. 4 illustrates access node 110 in communication network 100. In some examples, access node 110 provides a cell the serves a geographic area. The cell is divided into a near cell, cell center, and cell edge. The near cell is the served geographic area most proximate to radio circuitry 112, the cell edge is the served geographic area most distant to radio circuitry 112, and the cell center is the geographic area between near cell and the cell edge. In this example, the near cell ranges from 0-1 Kilometers (km), the cell center ranges from 1-5 km, and the cell edge ranges from 5-6 km. These numbers are exemplary and may differ in other examples. User devices attached to access node 110 within the cell are served on a radio band. Exemplary radio bands comprise N41, N25, and N71. N71 is a Frequency Division Duplex (FDD) 5G 600 MHz low-band frequency band. N25 is an FDD 5G 1900 MHz mid-band frequency band. N41 is a Time Division Duplex (TDD) 5G 2500 MHz mid-band frequency band. Other exemplary bands include the mid-band FDD 2100 MHz (N66), the mid-band TDD 3700 MHz (N77), the high-band Millimeter Wave (mmWave) TDD 24 GHz band, and the high-band mmWave 36 GHz band. The radio bands are divided into a number of resource blocks depending on the bandwidth. In this example, the cell's radio band comprises 100 total resource blocks (RBs), however this number is exemplary and may differ in other examples.

Processing circuitry 111 hosts a data structure that implements the table illustrated in FIG. 4. The table correlates timing advance signal (TA) to distances, distances to SINR threshold applicability, and SINR threshold outputs to resource block allocations. The timing advance signal indicates the amount of time it takes for signals to travel between radio circuitry 112 and user devices and is used to coordinate uplink transmission time for user devices. The table indicates a timing advance signal of 0-1 millisecond (ms) corresponds to a distance of 0-1 km which places the user device in the near cell. Near cell devices are exempt from the SINR threshold and may be allocated any of resource blocks 0-100. The table indicates a timing advance signal of 1-6 ms corresponds to a distance of 1-5 km which places the user device in the cell center. Cell center devices are exempt from the SINR threshold and may be allocated any of resource blocks 0-100. A timing advance signal of 6-10 ms corresponds to a distance of 5-6 km which places the user device in the cell edge. Cell edge devices are not exempt from the SINR threshold. The SINR threshold of the table is set to 1, however the threshold value may differ in other examples. SINR greater than 1 indicates received signal power exceeds received interference power. SINR equal to 1 indicates a 1:1 ratio between received signal power and received interference power. SINR less than 1 indicates received signal power is less than received interference power. When the reported SINR is greater than the SINR threshold, the table indicates user devices in the cell edge may be allocated any of resource blocks 0-100 as cell edge interference is acceptable. When the reported SINR is less than the SINR threshold, the table indicates user devices in the cell edge are restricted to resource blocks 80-100 as cell edge interference is high.

User device 101 wirelessly transfers a timing advance signal to processing circuitry 111 over radio circuitry 112. User device 101 measures SINR at its location and transfers a measurement report indicating the SINR to processing circuitry 111 over radio circuitry 112.

Processing circuitry 111 inputs the SINR and timing advance for user device 101 into the reservation table. In this example, user device 101 is located in the cell edge and is experiencing threshold interference. The reservation table correlates user device 101's timing advance signal to a distance of 5-6 km. In response, the table applies the SINR threshold and determines user device 101's SINR is less than 1. The table outputs a resource block indication for user device 101 that user device 101 may be allocated resource blocks 80-100. Processing circuitry 111 schedules downlink transmissions for user device 101 in resource blocks 80-100 and controls radio circuitry 112 to wirelessly transmit downlink data to user device 101 based on the schedule. When edge resource block reservation is in place (i.e., when the SINR threshold is triggered), processing circuitry 111 coordinates with neighboring access nodes (not illustrated) to inhibit the neighboring access nodes from scheduling their cell edge devices in resource blocks 80-100 to mitigate interference conditions in the cell edge of access node 110.

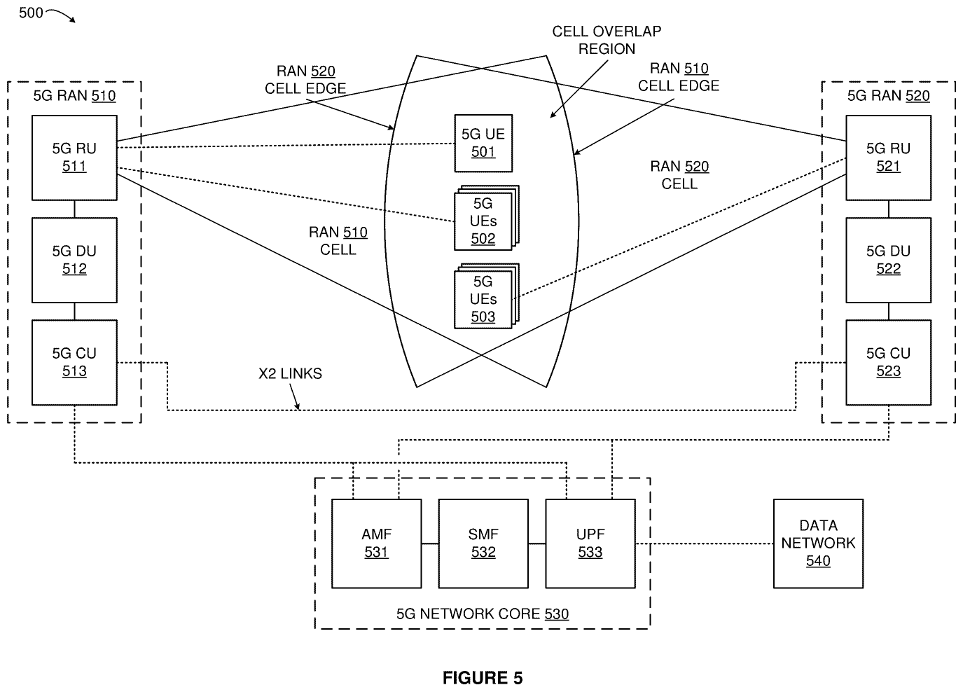

FIG. 5 illustrates 5G communication network 500 to reserve resource blocks for cell edge User Equipment (UE). 5G communication network 500 comprises an example of communication network 100 illustrated in FIG. 1, however communication network 100 may differ. 5G communication network 500 comprises 5G UE 501, 5G UEs 502, 5G UEs 503, 5G RAN 510, 5G RAN 520, 5G network core 530, and data network 540. 5G RAN 510 comprises 5G RU 511, 5G DU 512, and 5G CU 513. 5G RAN 520 comprises 5G RU 521, 5G DU 522, and 5G CU 523. 5G network core 530 comprises AMF 531, SMF 532, and UPF 533. Other network functions and network entities like PCF, UDM, Authentication Server Function (AUSF), Network Slice Selection Function (NSSF), Charging Function (CHF), Home Subscriber Register (HLR), HSS, Network Repository Function (NRF), Unified Data Registry (UDR), Short Message Service Function (SMSF), Network Exposure Function (NEF), Application Function (AF), Equipment Identity Register (EIR), and Session Communication Proxy (SCP) are typically present in 5G network core 530 but are omitted for clarity. In other examples, 5G communication network 500 may comprise different or additional elements than those illustrated in FIG. 5.

In some examples, 5G RANs 510 and 520 serve UEs 501-503 over radio channels within their respective cells. UEs 501-503 are representative of cell edge UEs for their respective RANs. As illustrated in FIG. 5, the edges of the cells for 5G RANs 510 and 520 overlap. 5G UEs 501-503 are served by RANs 510 and 520 and are located in the overlap region. UE 501 detects a reference signal broadcast by RAN 510 and decides to attach. UE 501 wirelessly attaches to 5G RAN 510 over a 5GNR link and transfers random preamble to RAN 510 initiating a Random Access Channel (RACH) procedure to establish a secure signaling channel. RAN 510 receives the preamble and assigns a Cell-Radio Network Temporary Identifier (C-RNTI) to UE 501. RAN 510 assigns time and frequency domain resources (i.e., resource blocks) to UE 501 for the RACH process. RAN 510 derives the timing advance for UE 501 based on the message transmission time and message reception time of the preamble. RAN 510 determines the distance between UE 501 and RAN 510 based on the timing advance and responsively designates UE 501 as an edge UE. In other examples, UE 501 may report its location (e.g., by measuring its GPS coordinates) to RAN 510 and RAN 510 may determine distance between UE 501 and RAN 510 based on the location report and responsively designate UE 501 as an edge UE.

RAN 510 wirelessly transfers a random access response to UE 501. The random access response includes a timing advance command, uplink grant, and the C-RNTI. The uplink grant indicates the time and frequency domain resources assigned to UE 501. UE 501 wirelessly receives the random access response. UE 501 extracts the uplink grant and timing advance command from the response. UE 501 transfers an RRC setup request to RAN 510 using the frequency and time resources assigned by the uplink grant at the time indicated by the timing advance command. The RRC setup request comprises a UE identity indication and the establishment cause. RAN 510 establishes a radio signaling bearer for UE 501 and transfers an RRC setup message to UE 501. The RRC setup message comprises a radio bearer configuration and cell ID. UE 501 establishes an RRC connection with RAN 510 using the radio bearer configuration and cell ID.

UE 501 transfers a registration request to AMF 531 over 5G RAN 510 and the radio signaling bearer. The registration request indicates a registration type, 5G-Global Unique Temporary Identifier (GUTI), Tracking Area Identifier (TAI), Network Slice Selection Assistance Information (NSSAI) requests, UE capabilities, PDU session requests, and the like.

In response to the registration request, AMF 531 transfers a Non-Access Stratum (NAS) identity request to UE 501 over RAN 510 and the radio signaling bearer. UE 501 indicates its Subscriber Concealed Identifier (SUCI) to AMF 531 over 5G RAN 510. AMF 531 interfaces with other network functions to authenticate the identity of UE 501. Typically, authentication involves presenting a random number challenge to UE 501 and matching an authentication response from UE 501 with an expected result to verify the identity of UE 501.

Responsive to the authentication, AMF 531 interfaces with other network functions to generate context for UE 501. The UE context defines the authorized services for UE 501. To form the context, AMF 531 retrieves access and mobility subscription data, SMF selection subscription data, and UE context in SMF data from a network data system. The access and mobility subscription data comprises a supported feature list for UE 501 (e.g., Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data comprises a supported feature list, and a list of allowed S-NSSAIs and associated information. The UE context in SMF data comprises PDU session and EPC interworking information. AMF 531 forms the UE context for UE 501 using the retrieved information. AMF 531 interfaces with other network functions to retrieve policy association information for UE 501. The policy association information comprises the SUPI, GPSI, PEI, and user location information for UE 501.

AMF 531 selects SMF 532 to serve UE 501 based on SMF selection data, the policy association information, and/or the network slice assigned to UE 501. AMF 531 transfers a list of requested PDU sessions (as received during the registration request), a PDU session activation command, and the SUPI to SMF 532. SMF 532 receives the PDU session list, session activation command, and the SUPI from AMF 531. SMF 532 allocates IP addresses to UE 501 for the requested PDU sessions and allocates a TEID for the session. SMF 532 selects UPF 533 to serve UE 501. SMF 532 transfers a session modification request that includes a session endpoint identifier and TEID to UPF 533 to set up the PDU sessions for UE 501. UPF 533 sets up a default bearer for UE 501 with 5G RAN 510. The default bearer is a link to carry IP packets for UE 501's PDU session. UPF 533 transfers a session modification response to SMF 532 that includes the session endpoint identifier to confirm bearer setup.

SMF 532 returns a PDU session create response to AMF 531 to confirm session creation. The response includes the updated session context (e.g., allocated IP addresses, TEID, etc.). In response, AMF 531 registers UE 501 for service on 5G network core 530. AMF 531 generates a registration accept message that includes the allocated UE IP address, RAN ID, AMBR, Globally Unique AMF ID (GUAMI), PDU session ID, PDU session TEID, allowed NSSAI list, security data, and the like. AMF 531 transfers the registration accept message to 5G RAN 510 to direct RAN 510 to serve UE 501.

5G RAN 510 schedules uplink and downlink resource blocks for UE 501 to assign time and frequency domain resources for the PDU session based on the registration accept message. 5G RAN 510 transfers an RRC reconfiguration message to UE 501 to setup the data radio bearers. The message includes cell IDs, bearer configuration information, and the like. UE 501 configures its radio bearers using the received information. UE 501 begins its PDU session on 5G communication network 500. RAN 510 wirelessly exchanges user data with UE 501 using the resource blocks assigned to UE 501. RAN 510 exchanges the user data with UPF 533 which in turn exchanges the user data with data network 540.

UEs 501 and 502 measure SINR at their locations and report the measured SINR to 5G RAN 510. 5G UEs 503 measure SINR at their locations and report the measured SINR to 5G RAN 520. 5G RANs 510 and 520 tracks the number of cell edge UEs based on the timing advance signals from their respective UEs. 5G RANs 510 and 520 exchange the reported SINR and number of UEs for their respective cell edges over their X2 links. 5G RAN 510 implements a serving cell SINR threshold, neighbor cell SINR threshold, serving cell edge loading threshold, and neighbor cell edge loading threshold to detect when to enter cell edge interference mitigation mode. During cell edge interference mitigation mode, RANs 510 and 520 reserve resource blocks for edge UEs. 5G RAN 510 compares the SINR reported by UEs 501 and 502 to the serving cell SINR threshold. 5G RAN 510 compares the neighbor cell edge SINR reported by RAN 520 to the neighbor cell SINR threshold. 5G RAN 510 compares the number of edge UEs it serves to the serving cell loading threshold. 5G RAN 510 compares the number of edge UEs reported by 5G RAN 520 the neighbor cell loading threshold. When one or more of the thresholds are triggered, 5G RAN 510 enters cell edge interference mitigation mode and restricts UEs 501 and 502 to a set of resource blocks reserved for edge UEs. 5G RAN 520 implements analogous thresholds and enters cell edge interference mitigation mode as described for RAN 510 when any of its thresholds are triggered. Since 5G RAN 520 implements analogous thresholds, it should be appreciated that when a cell edge loading/interference threshold is triggered in RAN 510 or 520, a corresponding threshold triggers in the neighboring RAN. For example, when the serving cell SINR threshold triggers in 5G RAN 510, the neighbor cell SINR threshold triggers in 5G RAN 520. In addition to the threshold triggers, 5G RANs 510 and 520 may enter cell edge interference mitigation mode (i.e., begin reserving resource blocks for edge UEs) in response to neighbor cell request and/or operator command. This may occur in cases where RANs 510 and 520 do not implement analogous thresholds.

In response to threshold trigger or notification, RAN 510 schedules additional downlink user data transmission to UE 501 in the resource blocks reserved for edge user devices. RAN 510 wirelessly exchanges the additional downlink user data with UE 501 using the reserved resource blocks based on the scheduling. RAN 510 interfaces with RAN 520 to coordinate the edge UE resource block reservation. In particular, RANs 510 and 520 coordinate to avoid reserving edge resource blocks that share the same time or frequency domain to reduce intercell interference at their cell edges. For example, RANs 510 and 520 may both have 100 resource blocks that share the same time/frequency domain for wireless communications.

During threshold conditions, RAN 510 may transfer a resource block reservation message to RAN 520 that indicates RAN 510 is in cell edge interference mitigation mode and that RAN 510 is restricting UEs 501-502 to resource blocks 80-100. In response RAN 520 may restrict UEs 503 to resource blocks 40-60.

In some examples, RAN 510 may select the reserved resource blocks based on factors like bandwidth, number of total resource blocks, operator selection, or machine learning output. For example, RAN 510 may host a machine learning model trained to select resource block reservations for edge UEs. RAN 510 may provide a list of available resource blocks to the model and the model may process the input with its constituent algorithms and provide an output to RAN 510 with the resource block selection. RAN 510 may then reserve the resource blocks based on the model output. A machine learning model comprises one or more machine learning algorithms that are trained based on historical data and/or other types of training data. A machine learning model may employ one or more machine learning algorithms through which data can be analyzed to identify patterns, make decisions, make predictions, or similarly produce output. Examples of machine learning algorithms that may be employed solely or in conjunction with one another include Large Language Models (LLMs), Three Dimensional (3D) deep leaning models, 3D convolutional neural networks, times series convolutional deep learning, transformers, multi-layer perceptron, long term short memory, and attention based deep learning model. Other exemplary machine learning algorithms include artificial neural networks, nearest neighbor methods, ensemble random forests, support vector machines, naïve Bayes methods, linear regressions, or similar machine learning techniques or combinations thereof capable of predicting output based on input data.

In some examples, 5G RAN 510 may map its cell edge. It should be appreciated that 5G communication network 500 may be large and geographically diverse with many thousands of RANs. Topographical conditions and radio technologies may differ between the RANs. As such, the size of the cells and locations of the cell edges may differ between the RANs. It is difficult and labor intensive for network operators to precisely map out the cell edge for every RAN in 5G communication network 500. 5G RAN 510 may autonomously map its cell edge based on historical data like historical SINR measurements, historical timing advanced signals, and/or other historical data that characterizes the location of the cell edge. For example, RAN 510 may receive historical SINR measurements from historical UEs (not illustrated) and determine the locations of the historical UEs. RAN 510 may map (e.g., in the served geographic area) the SINR measurements based on the locations and define a geographic area that forms the cell edge based on the SINR measurements. For example, RAN 510 may define the cell edge based on the locations of historical SINR measurements that exceed a threshold as interference tends to increase near the cell edge. For example, RAN 510 may receive historical timing advance signals from historical UEs and determine the distances between the historical UEs and RAN 510 based on the timing advance signals. RAN 510 may plot the distances (e.g., to determine their statistical distribution) and define a geographic area that forms the cell edge based on the distances that exceed a threshold. These thresholds may be operator or autonomously selected. For example, RAN 510 may host a machine learning model trained to select a geographic area that forms the cell edge. RAN 510 may provide historical SINR measurements and/or historical timing advance signals to the model. The model may then generate an output that recommends a cell edge for RAN 510. RAN 510 may select a geographic area to form the cell edge based on the model output. The cell edge is typically defined as a distance from RAN 510. For example, the model output may indicate the cell edge comprises 8-10 km from RU 511 in RAN 510.

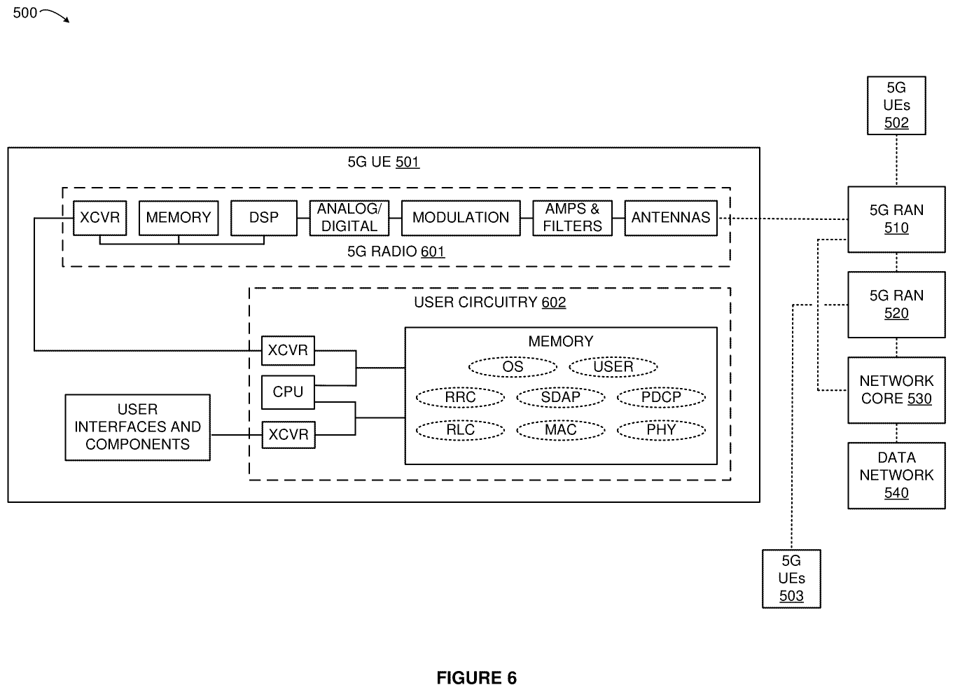

FIG. 6 illustrates UE 501 in 5G communication network 500. UE 501 comprises an example of user device 101 illustrated in FIG. 1, although user device 101 may differ. UEs 502 and 503 comprise similar architecture to UE 501. UE 501 comprises 5G radio 601 and user circuitry 602. 5G radio 601 comprises 5GNR antennas, amplifiers, filters, modulation, analog-to-digital interfaces, Digital Signal Processers (DSP), memory, and transceivers (XCVRs) that are coupled over bus circuitry. User circuitry 602 comprises memory, CPU, user interfaces and components, and transceivers that are coupled over bus circuitry.

The memory in user circuitry 602 stores an operating system (OS), user applications (USER), and 5GNR network applications for PHY, MAC, RLC, PDCP, SDAP, and RRC. The antenna in 5G radio 601 is wirelessly coupled to 5G RAN 510 over a 5GNR link. Transceivers in radio 601 are coupled to a transceiver in user circuitry 602. A transceiver in user circuitry 602 is typically coupled to user interfaces and components like displays, controllers, and memory.

In 5G radio 601, the antennas receive wireless signals from 5G RAN 510 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 602 over the transceivers. In user circuitry 602, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In 5G radio 601, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 510 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs).

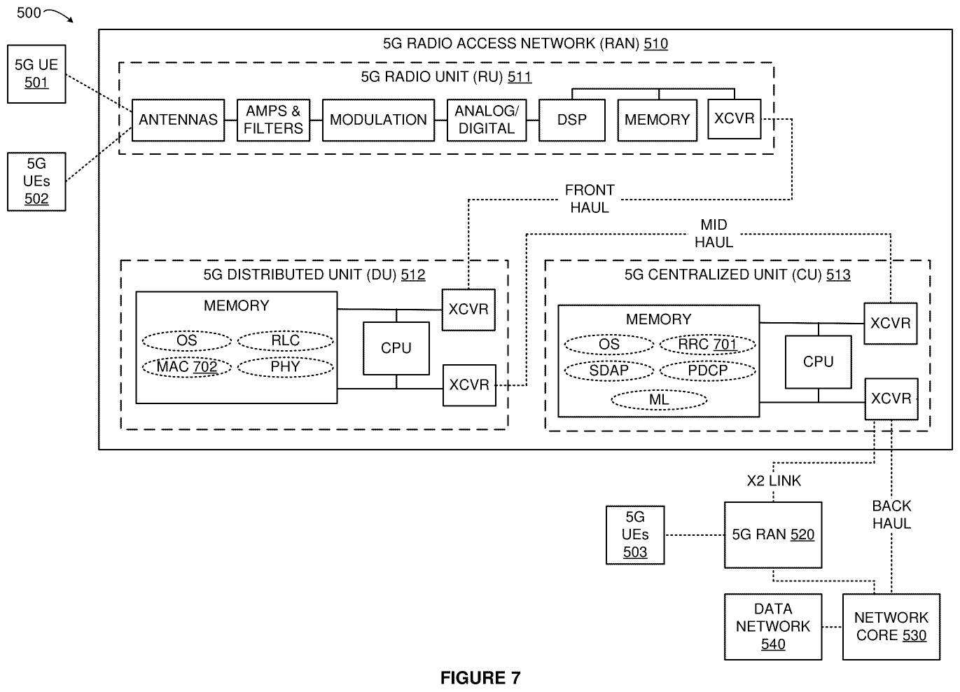

FIG. 7 illustrates 5G RAN 510 in 5G communication network 500. 5G RAN 510 comprises an example of the access node 110 illustrated in FIG. 1, although access node 110 may differ. 5G RAN 520 comprises a similar architecture to 5G RAN 510. RU 511 comprises 5GNR antennas, amplifiers, filters, modulation, analog-to-digital interfaces, DSP, memory, and transceivers (XCVRs) that are coupled over bus circuitry. UE 501 is wirelessly coupled to antennas in RU 511 over 5GNR links. Transceivers in RU 511 are coupled to transceivers in DU 512 over fronthaul links like enhanced Common Public Radio Interface (eCPRI). The DSPs in RU 511 executes their operating systems and radio applications to exchange 5GNR signals with UE 501 and to exchange 5GNR data with DU 512.

For the uplink, the antennas in RU 511 receive wireless signals from UE 501 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 512 over the transceivers.

For the downlink, the DSPs receive downlink 5GNR symbols from DU 512. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 501 that transport the downlink 5GNR signaling and data.

DU 512 comprises memory, CPU, and transceivers that are coupled over bus circuitry. The memory in DU 512 stores operating systems and 5GNR network applications like PHY, MAC 702, and RLC. CU 513 comprises memory, CPU, and transceivers that are coupled over bus circuitry. The memory in CU 513 stores an operating system, 5GNR network applications like PDCP, SDAP, and RRC 701, and a machine learning model. Transceivers in DU 512 are coupled to transceivers in RU 511 over front-haul links. Transceivers in DU 512 are coupled to transceivers in CU 513 over mid-haul links. A transceiver in CU 513 is coupled to 5G network core 530 over backhaul links and to 5G RAN 520 over X2 links.

RLC functions comprise ARQ, sequence numbering and resequencing, segmentation and resegmentation. MAC 702 functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC 701 functions include authentication, security, handover control, status reporting, QoS, network broadcasts and pages, network selection, edge resource block reservation, interference threshold monitoring, load threshold monitoring, neighbor RAN interfacing, cell edge mapping and reserved resource block selection. ML functions include cell edge mapping support and reserved resource block selection support.

In some examples, RRC 701 receives SINR measurements and timing advance signals from UEs 501 and 502. RRC 701 calculates the distance between RU 511 and UEs 501 and 502 based on the timing advance signal to track which UEs are in the cell edge and determine cell edge loading. RRC 701 derives average SINR for the cell edge based on the SINR measurements from UEs 501 and 502. RRC 701 communicates the average cell edge SINR and cell edge loading for RAN 510 to RAN 520 over the X2 links. RRC 701 receives average neighbor cell edge SINR and neighbor cell edge loading from RAN 520 over the X2 links. RRC 701 applies the SINR and loading measurements for its cell and the neighbor cell to SINR and loading thresholds to determine when to enter cell edge interference mitigation mode.

When the serving or neighbor cell SINR falls below a SINR threshold, or when serving or neighbor cell loading exceed a loading threshold, RRC 701 controls RAN 510 to enter cell edge interference mitigation mode. During cell edge interference mitigation mode, RRC 701 reserves a portion of the downlink resource blocks for cell edge UEs and directs MAC 702 to schedule downlink signaling/data to UEs 501 and 502 using the reserved resource blocks. RRC 701 coordinates with RAN 520 over the X2 links to reserve the portion of the resource blocks and avoid reserving the same resource blocks for their respective edge UEs. MAC 702 schedules UEs 501 and 502 to for downlink signaling/data in the resource blocks reserved for cell edge UEs. RRC 701 continues monitoring serving and neighbor cell SINR and loading. When the SINR and loading thresholds are no longer triggered, RRC 701 controls RAN 510 to exit cell edge interference mitigation mode. RRC 701 directs MAC 702 to schedule downlink signaling/data to UEs 501 and 502 any available resource block. MAC 702 schedules UEs 501 and 502 to for downlink signaling/data using any available resource block.

In some examples, RRC 701 utilizes the machine learning model in CU 513 to select the resource blocks to reserve for edge UEs. The machine learning model comprises algorithms trained to select resource blocks to reserve for edge UEs based on factors like bandwidth, frequency band, number of total resource blocks, operator rules, and the like. RRC 701 generates feature vectors that represent all of the resource blocks available to MAC 702 for scheduling. A feature vector is a numeric representation of data interpretable by a machine learning model. The model processes the feature vectors to generate an output recommending a set of resource blocks to restrict cell edge UEs to during cell edge interference mitigation mode. RRC 701 selects the resource blocks to reserve for the edge UEs based on the model output and/or coordination with RAN 520.

In some examples, RRC 701 maps the cell edge of 5G RAN 510 based on historical SINR measurements, historical timing advanced signals, and/or other historical data that characterizes the location of the cell edge. RRC 701 receives historical SINR measurements and historical timing advance signals from historical UEs. RRC 701 determines the distances/locations of the historical uses based on the timing advance signal. RRC 701 maps the historical SINR measurements based on the locations of the historical UE. RRC 701 defines a geographic area that forms the cell edge by clustering ones of the historical SINR measurements that exceed a threshold value as interference tends to increase near the cell edge. Alternatively, RRC 701 may define the cell edge based on the historical timing advance signals and locations of the historical UEs without accounting for historical SINR. For example, RRC 701 may bucket the historical distances to form a histogram representing the distances of all historical UEs and then define the cell edge based on the distribution depicted by the histogram (e.g., by defining the most distance quarter of historical UEs as being within the cell edge).

In some examples, the machine learning model in CU 513 comprises algorithms trained to map the cell edge based on factors like historical SINR, historical timing advance signals, historical UE locations, and/or other historical data. RRC 701 may generate feature vectors representing the historical data and provide the feature vectors to the machine learning model. The machine learning model processes the feature vectors with its trained algorithms to generate a machine learning output. The output comprises a distance range from RU 511 (e.g., 5-6 km) and RRC 701 may define the cell edge based on the recommended distance range.

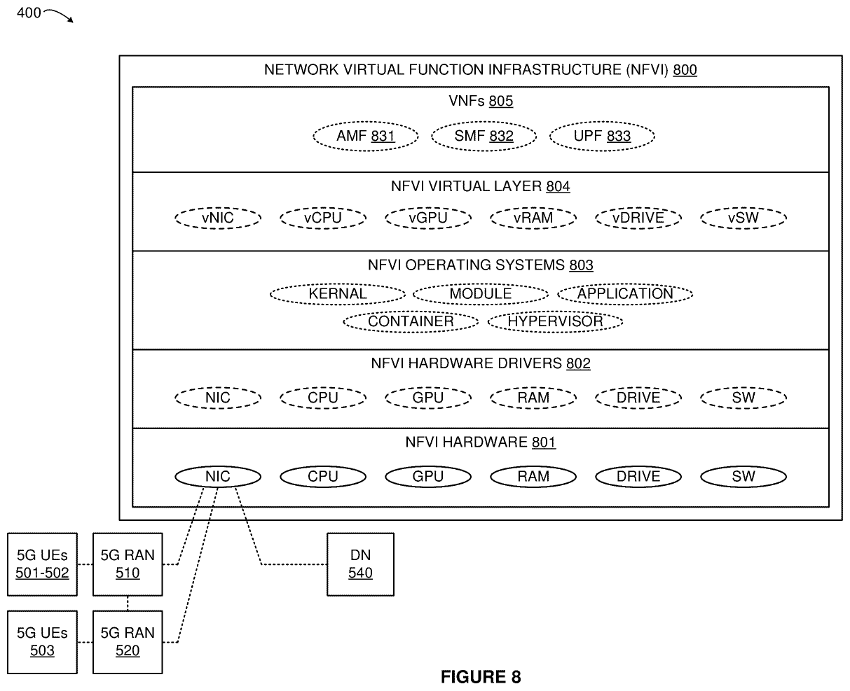

FIG. 8 illustrates NFVI 800 in 5G communication network 500. NFVI 800 comprises an example of core network 120 illustrated in FIG. 1, although core network 120 may differ. NFVI 800 comprises NFVI hardware 801, NFVI hardware drivers 802, NFVI operating systems 803, NFVI virtual layer 804, and NFVI Virtual Network Functions (VNFs)/Cloud-Native Network Functions (CNFs) 805. NFVI hardware 801 comprises Network Interface Cards (NICs), CPU, GPU, RAM, Flash/Disk Drives (DRIVE), and Data Switches (SW). NFVI hardware drivers 802 comprise software that is resident in the NIC, CPU, GPU, RAM, DRIVE, and SW. NFVI operating systems 803 comprise kernels, modules, applications, containers, hypervisors, and the like. NFVI virtual layer 804 comprises vNIC, vCPU, vGPU, vRAM, vDRIVE, and vSW. NFVI VNFs/CNFs 805 comprise AMF 831, SMF 832, and UPF 833. Additional VNFs/CNFs like AUSF, PCF, UDR, UDM, NSSF, CHF, HLR, HSS, NRF, SMSF, NEF, AF, EIR, and SCP are typically present but are omitted for clarity. NFVI 800 may be located at a single site or be distributed across multiple geographic locations. The NIC in NFVI hardware 801 is coupled to 5G RAN 510, data network 540, and to external systems (not illustrated). NFVI hardware 801 executes NFVI hardware drivers 802, NFVI operating systems 803, NFVI virtual layer 804, and NFVI VNFs/CNFs 805 to form AMF 531, SMF 532, and UPF 533.

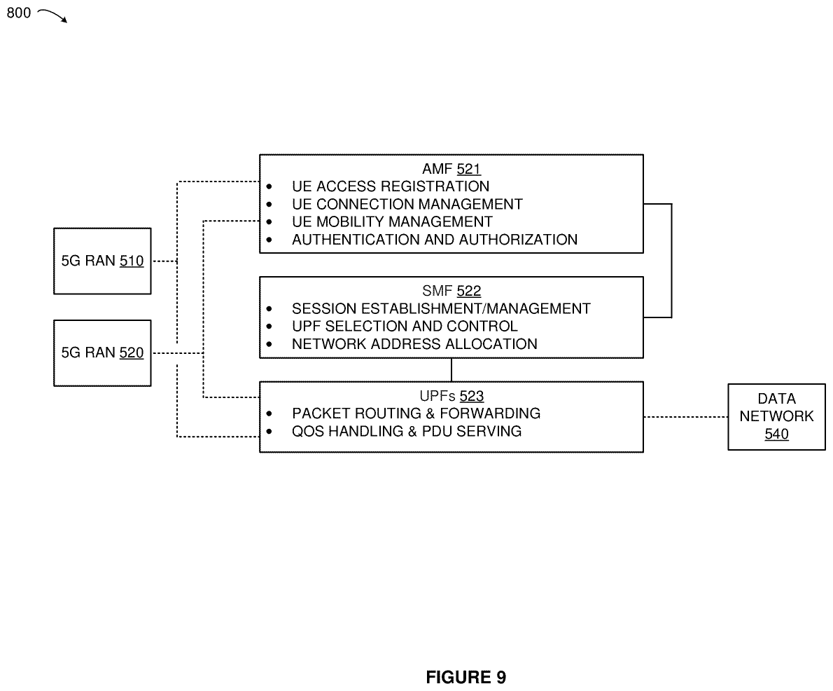

FIG. 9 further illustrates NFVI 800 in 5G communication network 500. AMF 531 comprises capabilities for UE registration, UE connection management, UE mobility management, authentication, and authorization. SMF 532 comprises capabilities for session establishment, session management, UPF selection, UPF control, and network address allocation. UPF 533 comprises capabilities for packet routing, packet forwarding, QoS handling, and PDU serving.

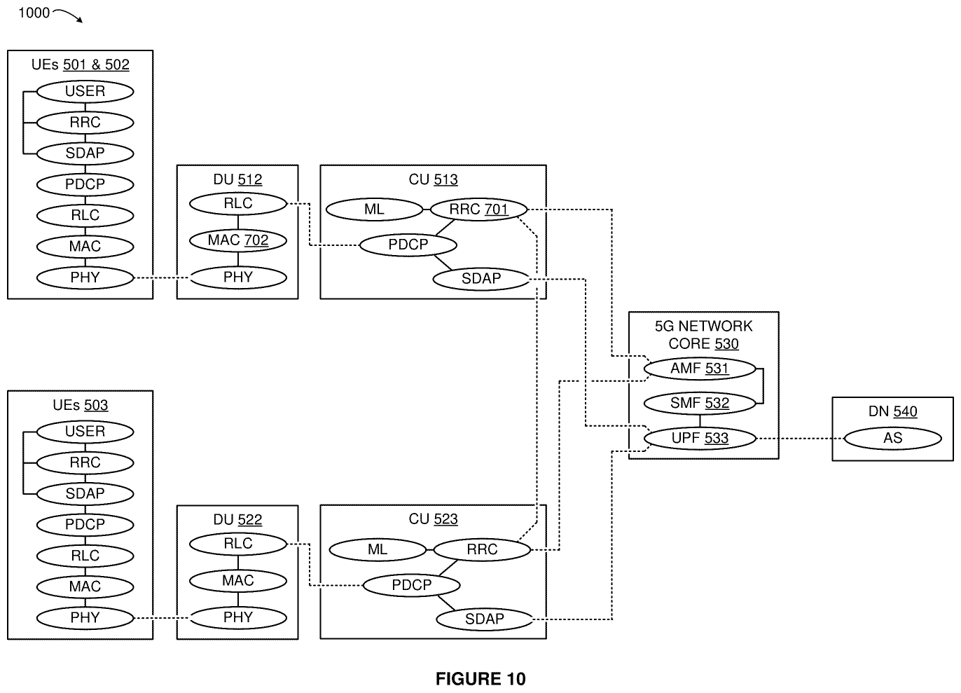

FIG. 10 illustrates process 1000. Process 1000 comprises an exemplary operation of 5G communication network 500 to reserve resource blocks for cell edge UE. Process 1000 comprises an example of processes 200 and 300 illustrated in FIGS. 2 and 3, however processes 200 and 300 may differ. Process 1000 may vary in other examples. In some examples, RRC 701 directs SDAP to serve a PDU session to UE 501 in response to receiving a registration accept message from AMF 531. RRC 701 directs MAC 702 to schedule UE 501 for wireless service. At this point, RAN 510 is not in edge interference mitigation mode and therefore all available resource blocks in UE 501's radio channel are available for UE 501. MAC 702 schedules uplink/downlink transmissions in the available resource blocks. The user application in UE 501 and the AS in data network 540 generate user data for the session. The SDAP in UE 501 exchanges the user data with the SDAP in CU 513 over the PDCPs, RLCs, MACs, and PHYs using the resource blocks scheduled by MAC 702. The SDAP in CU 513 exchanges the user data with UPF 533. UPF 533 exchanges the user data with data network 540. SMF 532 monitors and controls UPF 533 to support the session.

The RRC in UE 501 directs the PHY to measure SINR at the location of UE 501. The PHY analyzes the digital signal from radio 601 to measure the received power from RAN 510 and from interference sources. The PHY provides the measurements to the RRC which then calculates SINR. The RRC generates a measurement report that indicates the SINR and transfers the measurement report to RRC 701 in CU 513 over the PDCPs, RLCs, MACs, and PHYs. UEs 502 also measure and report SINR at their locations to RRC 701 in a similar manner to UE 501. The RRCs in UEs 503 direct their respective PHYs to measure SINR. The PHYs measure received power and received noise and report the measurements to the RRCs. The RRCs calculate SINR at the locations of UEs 503 based on the measurements and transfer measurement reports that indicate the SINR to the RRC in CU 523 over the PDCPs, RLCs, MACs, and PHYs.

RRC 701 receives the measurement reports from UEs 501 and 502. RRC 701 calculates the distances between RU 511 and UEs 501 and 502 based on the timing advance used to transfer the measurement reports. RRC 701 compares the distances to a cell edge distance threshold, determines the distances exceed the threshold, and classifies UEs 501 and 502 as edge UEs. RRC 701 tracks the total number of RRC connected edge UEs. The RRC in CU 523 calculates the distances of UEs 503, classifies UEs 503 as edge UEs, and tracks the number of edge UEs in a similar manner. RRC 701 sums the SINR measurements from UEs 501 and 502 and divides the sum by the total number of measurements to calculate average SINR at the cell edge. RRC 701 reports the average SINR and the total number of RRC connected edge UEs for its cell edge to the RRC in CU 523 over their X2 interface. The RRC in CU 523 similarly calculates average SINR for UEs 503 and reports the average SINR and total number of RRC connected edge UEs for its cell edge to RRC 701 over their X2 interface.

RRC 701 compares the average SINR for UEs 501 and 502 to a serving cell SINR threshold, compares its total number of edge UEs to a serving cell edge loading threshold, compares the average SINR reported by the RRC in CU 523 to a neighbor cell SINR threshold, and compares the total number of edge UEs reported by the RRC in CU 523 to a neighbor cell edge loading threshold. Similarly, the RRC in CU 523 compares the average SINR for UEs 503 to a serving cell SINR threshold, compares its total number of edge UEs to a serving cell edge loading threshold, compares the average SINR reported by RRC 701 to a neighbor cell SINR threshold, and compares the total number of edge UEs reported RRC 701 to a neighbor cell edge loading threshold. In this example, the average SINR in the serving cell of RAN 510 exceeds the serving cell SINR threshold (e.g., average SINR is less than one). As such, RRC 701 detects that the serving cell SINR threshold is triggered and the RRC in CU 523 detects that the neighbor cell SINR threshold is triggered.

In response to the triggered thresholds, 5G RANs 510 and 520 enter edge interference mitigation mode. When in edge interference mitigation mode, RANs 510 restrict the resource blocks available to edge UEs so that edge UEs in their respective cells are allocated different time domain and frequency domain resources for downlink transmissions. In doing so, RANs 510 and 520 avoid sending downlink data and signaling to their respective edge UEs at the same time and/or same frequency. To enter edge interference mitigation mode, RRC 701 interfaces with the machine learning model in CU 513 to select resource blocks to reserve. RRC 701 generates feature vectors that represent the resource blocks in the radio channel(s) supported by RU 511. The machine learning model comprises algorithms trained to select resource blocks to reserve for edge UEs. The machine learning model processing the feature vectors and generates a recommendation that indicates a set of resource blocks reserved for edge UEs attached to RAN 510 and provides the recommendation to RRC 701. The RRC in CU 523 interfaces similarly with the machine learning model in CU 523 to generate a recommendation to reserve resource blocks for edge UEs attached to RAN 520.

RRC 701 and the RRC in CU 523 coordinate over their X2 interface to select resource blocks for their edge UEs based on their respective machine learning recommendations. In doing so, RRC 701 and the RRC in CU 523 avoid restricting their edge UEs to shared resource blocks. For example, RUs 511 and 521 may provide the same radio band that is 100 resource blocks wide. The machine learning model in CU 513 may recommend restricting edge UEs to resource blocks 80-100 and the machine learning model in CU 523 may recommend restricting edge UEs to resource blocks 70-90. RRC 701 and the RRC in CU 523 may then indicate their recommendations to each other and adjust the recommended resource blocks so that they no longer overlap. For example, the RRC in CU 523 may revise the machine learning recommendation to resource blocks 55-75 based on the coordination.

RRC 701 directs MAC 702 to restrict downlink transmissions to UEs 501 and 502 to the resource blocks selected for edge UEs attached to RAN 510. In should be appreciated that during edge interference mitigation mode, non-edge UEs attached to RAN 510 may be scheduled on all resource blocks served by RAN 510, including the resource blocks that edge UEs are restricted to. It should also be appreciated that uplink transmissions by the edge UEs are not restricted to the resource blocks selected for edge UEs. MAC 702 schedules UEs 501 and 502 for uplink transmissions on any available resource block and schedules UEs 501 and 502 for downlink transmissions on the resource blocks selected for edge UEs attached to RAN 510. The RRC in CU 523 interfaces similarly with the MAC in DU 522 to schedule UEs 503 on the resource blocks selected for edge UEs attached to RAN 520. The user applications in UEs 501-503 and the AS in data network 540 generate additional user data for the session. The SDAP in UE 501 transfers uplink user data to the SDAP in CU 513 over the PDCPs, RLCs, MACs, and PHYs using the resource blocks scheduled by MAC 702. The SDAP in CU 513 transfers downlink user data to the SDAP in UE 501 over the PDCPs, RLCs, MACs, and PHYs user the resource blocks reserved for edge UEs scheduled by MAC 702. The SDAP in CU 513 exchanges the additional user data with UPF 533 which in turn exchanges the user data with data network 540. The SDAPs in UEs 503 and CU 523, UPF 533, and the AS in data network 540 similarly exchange the additional user data.

The RRCs in UEs 501-503 control their respective PHYs to generate updated SINR measurements. The RRCs in UEs 501-503 report the updated SINR measurements respectively to RRC 701 and the RRC in CU 523 over the PDCPs, RLCs, MACs, and PHYs. RRC 701 and the RRC in CU 523 receive the updated SINR measurements from UEs 501-503. RRC 701 calculates updated distances between RU 511 and UEs 501 and 502 based on the timing advance of the measurement reports to redetermine the total number of RRC connected edge UEs. The RRC in CU 523 similarly redetermines the total number of RRC connected edge UEs for RAN 520. RRC 701 recalculates average SINR and reports the updated average SINR and the updated total number of RRC connected edge UEs for its cell edge to the RRC in CU 523 over their X2 interface. The RRC in CU 523 similarly calculates updated average SINR for UEs 503 and reports the average SINR and the updated total number of RRC connected edge UEs for its cell edge to RRC 701 over their X2 interface.

RRC 701 compares the updated average SINR for UEs 501 and 502 to the serving cell SINR threshold, compares its updated total number of edge UEs to the serving cell edge loading threshold, compares the updated average SINR reported by the RRC in CU 523 to the neighbor cell SINR threshold, and compares the updated total number of edge UEs reported by the RRC in CU 523 to the neighbor cell edge loading threshold. Similarly, the RRC in CU 523 compares the updated average SINR for UEs 503 to the serving cell SINR threshold, compares the updated total number of edge UEs to the serving cell edge loading threshold, compares the updated average SINR reported by RRC 701 to the neighbor cell SINR threshold, and compares the updated total number of edge UEs reported RRC 701 to the neighbor cell edge loading threshold. At this point, edge interference conditions in RAN 510's cell have subsided. As such, RRC 701 and the RRC in CU 523 determine that none of the thresholds are triggered and elect to leave edge interference mitigation mode. RRC 701 directs MAC 702 to stop restricting the available resource blocks for downlink transmissions to UEs 501 and 502. The RRC in CU 523 directs the MAC in DU 522 to stop restricting the available resource blocks for downlink transmissions to UEs 503. MAC 702 schedules further downlink transmissions to UEs 501 and 502 using all available resource blocks. The MAC in DU 522 schedules further downlink transmissions to UEs 503 using all available resource blocks.

The wireless data network circuitry described above comprises computer hardware and software that form special-purpose network circuitry to reserve resource blocks for cell edge devices. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to reserve resource blocks for cell edge devices.

Although the descriptions provided herein may be in the context of certain radio access technologies, networks, and network topologies, such as 5GNR mobile communications, the proposed concepts, schemes, and any variations thereof may be implemented in, for and by other types of radio access technologies, networks, and network topologies. Such radio access technologies, networks, and network topologies may include, for example and without limitation, LTE, Internet-of-Things (IoT), NB-IoT, Vehicle-to-Everything (V2X), fixed wireless internet, and Non-Terrestrial Network (NTN) communications. Thus, the scope of the disclosure is not limited to the examples described herein.

The above description and associated figures teach the best mode of the invention. For the purpose of teaching inventive principles, some conventional aspects of the best mode may be simplified or omitted. The following claims specify the scope of the invention. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described above, nor the best mode, but only by the claims and their equivalents.

What is claimed is:

1. A method comprising:
reserving a set of resource blocks for user devices located in a cell edge of a cell provided by an access node;
determining a user device is located in the cell edge;
scheduling the user device using the set of resource blocks reserved for the user devices located in the cell edge;
wirelessly exchanging user data with the user device based on the scheduling.

2. The method of claim 1 wherein reserving the set of resource blocks for the user devices located in the cell edge comprises:
coordinating with a neighboring access node to select a first set of resource blocks and a second set of resource blocks wherein the first set of resource blocks does not overlap with the second set of resource blocks; and
reserving the set of resource blocks for the user devices located in the cell edge using the first set of resource blocks wherein the neighboring access node reserves another set of resource blocks for other user devices located in an additional cell edge of a neighbor cell provided by the neighboring access node using the second set of resource blocks.

3. The method of claim 1 wherein reserving the set of resource blocks for the user devices located in the cell edge comprises:
hosting a machine learning model trained to reserve resource blocks for the user devices located in the cell edge;
providing a set of available resource blocks to the machine learning model; and
reserving the set of resource blocks for the user devices located in the cell edge based on an output from the machine learning model.

4. The method of claim 1 wherein reserving the set of resource blocks for the user devices located in the cell edge comprises reserving the set of resource blocks for the user devices located in the cell edge based on an operator selection.

5. The method of claim 1 wherein determining the user device is located in the cell edge comprises wirelessly receiving a timing advance signal from the user device, determining a distance of the user device based on the timing advance signal, and determining the user device is located in the cell edge based on the distance.

6. The method of claim 1 wherein determining the user device is located in the cell edge comprises wirelessly receiving a location report from the user device that includes Global Positioning System (GPS) coordinates of the user device and determining the user device is located in the cell edge based on the GPS coordinates.

7. The method of claim 1 further comprising determining a Signal-to-Interference-Plus-Noise Ratio (SINR) for the user devices located in the cell edge exceeds a SINR threshold; and wherein:
scheduling the user device in the set of resource blocks reserved for the user devices located in the cell edge comprises scheduling the user device in the set of resource blocks reserved for the user devices located in the cell edge in response to the exceeded SINR threshold.

8. The method of claim 1 further comprising determining an amount of the user devices located in the cell edge exceeds an edge loading threshold; and wherein:
scheduling the user device in the set of resource blocks reserved for the user devices located in the cell edge comprises scheduling the user device in the set of resource blocks reserved for the user devices located in the cell edge in response to the exceeded edge loading threshold.

9. The method of claim 1 further comprising receiving a notification from a neighboring access node that indicates a Signal-to-Interference-Plus-Noise Ratio (SINR) for other user devices located in an additional cell edge of the neighbor cell provided by the neighboring access node exceeds a neighbor cell SINR threshold; and wherein:
scheduling the user device in the set of resource blocks reserved for the user devices located in the cell edge comprises scheduling the user device in the set of resource blocks reserved for the user devices located in the cell edge in response to the exceeded neighbor cell SINR threshold.

10. The method of claim 1 further comprising receiving a notification from a neighboring access node that indicates an amount of other user devices located in a cell edge of a neighbor cell providing by the neighboring access node exceeds a neighbor cell edge loading threshold; and wherein:
scheduling the user device in the set of resource blocks reserved for the user devices located in the cell edge comprises scheduling the user device in the set of resource blocks reserved for the user devices located in the cell edge in response to the exceeded neighbor cell edge loading threshold.

11. The method of claim 1 further comprising:
wirelessly receiving historical Signal-to-Interference-Plus-Noise Ratio (SINR) measurements from historical user devices;
determining locations of the historical SINR measurements;
determining a set of the historical SINR measurements that exceed a SINR threshold; and
selecting a geographic area to form the cell edge based on the locations of the set of the historical SINR measurements that exceed the SINR threshold.

12. The method of claim 1 further comprising:
wirelessly receiving historical timing advance signals from historical user devices;
determining distances of the historical user devices based on the historical timing advance signals;
determining a set of the distances of the historical user devices that exceed a distance threshold; and
selecting a geographic area to form the cell edge based on the set of the distances of the historical user devices that exceed the distance threshold.

13. The method of claim 1 further comprising:
wirelessly receiving historical Signal-to-Interference-Plus-Noise Ratio (SINR) measurements from historical user devices;
hosting a machine learning model trained to select geographic areas to form cell edges based on SINR measurements;
providing the historical SINR measurements to the machine learning model; and
selecting a geographic area to form the cell edge based on an output from the machine learning model.

14. A system comprising:
processing circuitry configured to:
reserve a set of resource blocks for user devices located in a cell edge of a cell provided by an access node;
determine a user device is located in the cell edge; and
schedule the user device in the set of resource blocks reserved for the user devices located in the cell edge; and
radio circuitry configured to:
wirelessly exchange user data with the user device based on the schedule.

15. The system of claim 14 wherein the processing circuitry is further configured to:
coordinate with a neighboring access node to select a first set of resource blocks and a second set of resource blocks wherein the first set of resource blocks does not overlap with the second set of resource blocks; and
reserve the set of resource blocks for the user devices located in the cell edge using the first set of resource blocks wherein the neighboring access node reserves another set of resource blocks for other user devices located in an additional cell edge of a neighbor cell provided by the neighboring access node using the second set of resource blocks.

16. The system of claim 14 wherein:
the radio circuitry is further configured to wirelessly receive a timing advance signal from the user device; and
the processing circuitry is further configured to determine a distance of the user device based on the timing advance signal and determine the user device is located in the cell edge based on the distance.

17. The system of claim 14 wherein the processing circuitry is further configured to:
determine a Signal-to-Interference-Plus-Noise Ratio (SINR) for the user devices located in the cell edge exceeds a SINR threshold; and
schedule the user device in the set of resource blocks reserved for the user devices located in the cell edge in response to the exceeded SINR threshold.

18. The system of claim 14 wherein the processing circuitry is further configured to:
determine an amount of the user devices located in the cell edge exceeds an edge loading threshold; and
schedule the user device in the set of resource blocks reserved for the user devices located in the cell edge in response to the exceeded edge loading threshold.

19. The system of claim 14 wherein the processing circuitry is further configured to:
receive a notification from a neighboring access node that indicates at least one of a Signal-to-Interference-Plus-Noise Ratio (SINR) for other user devices located in an additional cell edge of the neighbor cell provided by the neighboring access node exceeds a neighbor cell SINR threshold or an amount of the other user devices located in the additional cell edge of the neighboring cell exceeds a neighbor cell edge loading threshold; and
schedule the user device in the set of resource blocks reserved for the user devices located in the cell edge in response to at least one of the exceeded neighbor cell SINR threshold or the exceeded neighbor cell edge loading threshold.

20. One or more non-transitory computer readable storage media having program instructions stored thereon, wherein the program instruction, when executed by a computing system, direct the computing system to perform operations, the operations comprising:
reserving a set of resource blocks for user devices located in a cell edge of a cell provided by an access node;
determining a user device is located in the cell edge;
scheduling the user device in the set of resource blocks reserved for the user devices located in the cell edge; and
directing a radio to wirelessly exchange user data with the user device based on the scheduling.
